(19) United States
(12) Patent Application Publication
(10) Pub. No.: US 2011/0212808 A1
(43) Pub. Date: Sep. 1, 2011

(54) ROLLING BEARING ARRANGEMENT AND PLANETARY TRANSMISSION COMPRISING THE ROLLING BEARING ARRANGEMENT

(75) Inventor: Alexander PABST, ERLANGEN (DE)

(73) Assignee: SCHAEFFLER TECHNOLOGIES GMBH & CO. KG

(21) Appl. No.: 13/035,345

(22) Filed: Feb. 25, 2011

(30) Foreign Application Priority Data
Feb. 26, 2010 (DE) 10 2010 009 391.2

(51) Int. Cl. F16C 33/46; F16C 19/26; F16H 1/28; C21D 7/06

(52) U.S. Cl. 475/348; 384/572; 72/53

(57) ABSTRACT

A rolling bearing arrangement which has rolling elements and at least one cage guiding the rolling elements. The cage has at least one contact zone for sliding contact with a further contact zone.

This application claims the priority of DE 10 2010 009 391.2 filed Feb. 26, 2010, which is incorporated by reference herein.

### FIELD OF THE INVENTION

The invention concerns a rolling bearing arrangement comprising rolling elements and at least one cage guiding said rolling elements, said cage comprising at least one contact zone for sliding contact with a further contact zone of the rolling bearing arrangement. The invention further concerns a planetary transmission comprising at least one such rolling bearing arrangement revolving around a central axis of the planetary transmission.

### BACKGROUND OF THE INVENTION

The cages of the rolling bearing arrangements of the species in question, preferably of the needle or roller bearing type are circular ring-shaped, hollow cylindrical structures which, in an imaginary, plane development generally have a ladder or comb shape—ladder shape, in the sense that two longitudinal rods are connected crosswise to rungs—comb shape, in the sense that crosswise extending parallel prongs project in one direction or in two directions from one longitudinal rod. In the completed state, the longitudinal rods are the side edges of the cage and the rungs or prongs are the so-called crossbars. Because the side edges are situated at a distance from each other in axial direction and the crossbars of the cage are spaced from one another in circumferential direction, every two crossbars and every two sections of the side edges define rectangular empty fields, so-called pockets.

The pockets adjoining one another in circumferential direction are all separated from one another by one of the crossbars. As a rule, one roller is arranged in each of the pockets with axial and tangential lash to the edges and to the crossbars or rolling element retainers. However, cages also exist in which two or more rolling elements are arranged.

During operation of the rolling bearing, the rolling elements that roll about their own axis of rotation in the pockets, are retained and guided at a distance from one another. During operation of the rolling bearing, the axially oriented front ends of the rollers come to abut in axial direction against contact zones of the fractional sections of the side edges. Further, at certain points of their outer peripheral surfaces, the rollers strike against contact zones of the crossbars. Due to the relative movement of the rollers to the contact zones, in the best case, sliding contact is caused at these points, and in the worst case, wear.

The aforesaid rolling element retainers are either configured on the crossbars or are constituted by the crossbars themselves. These retainers retain the rollers in the non-assembled state of the rolling bearing against the action of gravitational force in the cage. In this state, the rollers are “suspended” on these retainers in the pockets.

Cages of rolling bearings must therefore be guided in radial direction. Where and how the cage is guided in radial direction depends on various factors. As a rule, one differentiates between internally guided cages, externally guided cages and cages guided on the rolling elements. The configuration of the crossbars and the existence of the retainers, their position and their spacing from one another on a pocket determine the manner in which a cage is guided in radial direction during operation of the rolling bearing.

The lash between the retainers and the rolling elements can be designed to be so small that, during operation of the rolling bearing, the cage is supported radially on the rolling elements, either through its own weight against the action of gravitational force, or against the influences of centrifugal forces through the contact zones of the crossbars or retainers. In this case, the cage is supported, not on the surroundings, i.e. for example, not on inner rolling contact surfaces, not on rims of inner rings, not on outer rolling contact surfaces or rims of outer rings but on the rolling elements. The relative movement of the rolling elements to the contact zones on the retainers or the crossbars results in the ideal case in sliding contacts in the contact zones of the retainers on the cage and, in the most unfavorable case, in wear. Such rolling bearings are used, for instance, in so-called idler pinion mountings in transmissions.

Idler pinions in transmissions are also designated as “constant mesh” pinions and are gearwheels on a transmission shaft that are constantly in mesh with a further gearwheel. When the idler pinions are not involved in the power flow, they are dragged and mounted for rotation on the transmission shaft through the idler pinion mounting, partially at very high speeds of rotation relative to the transmission shafts. During power flow (i.e. when a gear is engaged), the idler pinions are coupled rotationally fast to the shaft. OUR to the absence of relative speeds of rotation between the engaged idler pinion and the transmission shaft, the idler pinion mounting takes over static support functions. Through the rolling element guidance, the rollers or needles continue to be moved in circumferential direction on the raceway despite the absence of relative speeds of movement. In this way, it is prevented that the rolling elements work themselves into the raceways through micro movements at one point.

The distance of the retainers or crossbars on a cage can be so large that the cage is able to move freely to a certain extent in radial direction relative to the rolling elements in its design space with hindrance through the rolling elements. In this case, as a rule, the cages are supported, against the influence of gravitational force or centrifugal force, through cylindrical surfaces of their side edges on contact zones of cylindrical guide surfaces of the surroundings of the cages. The relative movement of the cages to the cylindrical guide surfaces results, in the ideal case, in sliding contacts and, in the most unfavorable force, in wear.

The type of guidance, inner or outer, through the cylindrical surfaces of the side edges, depends on the choice of the position of the guide surfaces on the pitch circle of the rolling bearing.

The pitch circle of the rolling bearing is a circle that extends around the axis of rotation of the rolling bearing and, in the nominal state of the bearing, traverses all the centers of rotation of the circumferentially distributed rolling elements. Centers of rotation are the axes of rotation of the rollers or the centers of balls.

Cages which comprise inner cylindrical guide surfaces are guided radially internally on outer cylindrical guide surfaces of the shaft or of the bearing ring. The outer diameter of the outer cylindrical guide surfaces is smaller than the diameter of the pitch circle of the respective rolling bearing. The cages are internally guided, for instance, on the outer cylindrical inner rolling contact raceway with which the rolling elements are in rolling contact. Often, the cages are internally guided through contact zones of inner cylindrical guide surfaces on contact zones of outer cylindrical guide surfaces of so-called guide rims of the inner rings. Such cages are used, for instance, for mounting pistons on piston pins of high speed internal combustion engines or as so-called filigree cages in full-complement bearings.

By filigree cages, in this case, are to be understood cages whose diameter is smaller than the pitch circle diameter and hardly larger than the diameter of the inner rolling contact raceway. By full-complement bearings are to be understood bearings in which the rollers are arranged in closely adjoining relationship behind one another near the pitch circle diameter, over the entire circumference. The dimensions of the crossbars of filigree cages are so filigree that one of the crossbars fits into each of the gaps that are naturally formed near the inner raceway between the curved contours of the cylindrical peripheral surfaces of successive adjoining rollers.

Cages which comprise contact zones on outer cylindrical guide surfaces are guided radially externally on contact zones of inner cylindrical guide surfaces. The diameter of the inner cylindrical guide surfaces is larger than the pitch circle diameter of the respective rolling bearing. The cages are externally guided, for instance, on the outer rolling contact raceway in bores, with which the rolling elements are in rolling contact. Often, the cages are externally guided on inner cylindrical guide surfaces of so-called guide rims of outer rings. Such cages are used, in particular, in rolling bearings in which high centrifugal forces act on the cages. Such rolling bearings are used, for instance, for mounting connecting rods on crank pins—so-called crank pin cages (KZK) or for mounting planet gears in planetary transmissions. The centrifugal forces are produced due to the fact that the rolling bearings rotate not only in themselves but also revolve in an orbit about an axis of rotation.

One example of use of rolling bearings with externally guided cages in which the so-called crank pin cages can also be used, are rolling bearings of planet gears in planets. These rolling bearing arrangements serve to mount the planet gears on planet pins which are arranged at a distance to the central axis of the planetary transmission and are exposed to high centrifugal forces because they rotate not only about their own axis of rotation but revolve, at least in some operational states after the manner of planets about the central axis of the planetary transmission in orbits. The centrifugal forces force not only the rolling elements but also the respective cage together with the side edges on the contact zones against the rolling contact raceway, so that the cage is guided radially externally on these. As a rule, the rolling contact raceway is configured directly in the bore of the respective planet gear. However, because the respective cage naturally rotates only at about half the speed of rotation of the planet gear about the axis of rotation, the side edges slide through outer guide surfaces on the inner cylindrical contact zones of the rolling contact raceway.

For this reason, the contact zones are particularly carefully machined. Thus, for example, the outer contours of the externally guided cages are very precisely ground for the contact with the external guide, and outer contours of the cage as also inner contours of the rolling contact raceway or of the guide rims are matched exactly to one another. Moreover, particular attention has also been paid in the past to the surface treatment of the contact zones with the aim of improving the abrasion resistance and sliding properties, particularly of the potential contact zones.

On the basis of the various methods described for the coating of cages. DE 295 22 273 U1 shows that great emphasis is laid on this subject and that the technical field is constantly endeavoring to achieve improvements in this respect. Hitherto known proposals are, for example, diffusion of nickel, plating of the original material of cages made of sheet metal, whereby plating is to be understood as joining a strip of base material to a covering material by rolling or pressing. Further, for instance, the crank pin cages are copper-plated and/or silver-plated, which improves the thermal economy of the rolling bearing arrangement. Besides this, due to certain self-lubrication properties, these materials improve the emergency running properties in case of deficient lubrication in the contact with the outer guide. Coatings of this type are relatively thin and therefore wear out in a relatively short time. In addition, coating with nonferrous heavy metals or noble metals is very expensive.

Rolling bearings of planet gears are generally lubricated by oil bath lubrication. The lubricating oil on the planet carrier is often “skimmed” at first upon plunging of the rolling bearing and then transported under the influence of centrifugal forces to the appropriate lubrication points. An adequate distribution of the oil, particularly on the contact zones of the outer guide, is not assured in every case. When the planet carrier is stationary, the rolling bearings situated outside of the oil sump are not adequately furnished with lubricating oil, so that, in particular in this case, deficient lubrication can occur at the contact of the rolling bearing with the cage.

Due to the high centrifugal forces, the elements of the cage are exposed to high loads and can even get deformed. For this reason, the technical field makes constant efforts to improve the stability of cages used in the mounting of planets. To begin with, more stable cages could be realized by strengthening the cross-sections of individual elements or of the endangered zones. However, through such measures, the mass of the cage and thus also the centrifugal forces acting on the cages as well as the loads in the contact with the guide zones are increased. Irrespective of this, the technical field endeavors to make the crank pin cages out of the thinnest possible sheet metals, also with a view to reducing costs.

### SUMMARY OF THE INVENTION

It is therefore an object of the invention to improve a rolling bearing arrangement of a usual type and a rolling bearing arrangement of a planetary transmission, so that the sliding contact in the contact zones of the cage of the rolling bearing arrangement with further contact zones in the rolling bearing arrangement, as well as the strength of the cage even under high loads can be assured in a simple and economic manner.

The above object is achieved by the rolling bearing arrangement of the present invention which has rolling elements and at least one cage, which has at least one contact zone for sliding contact with a further contact zone, guiding the rolling elements where the at least one contact zone for sliding contact has a surface with a maximum compressive residual stress of 900 to 1200 MPA obtained by blasting with solid particles, and extends with a changed value down to a depth of at least 0.25 mm vertically under the surface. The surface of the contact zone is created through blasting with solid particles, particularly by ball blasting. Ball blasting is a method using a blasting technique and this term is often used as an equivalent of the English term “shot peening.” In this method, small-grained blasting material is flung at a high speed against the surface of the contact zone to be treated.

The contact zones to be treated in this way for sliding contact in rolling bearings are:
contact zones on the side edges of the cages,
contact zones of the crossbars of the cages comprising the rolling elements, particularly
contact zones of the retainers of rolling element-guided cages comprising the rollers or needles of the rolling bearing, for example in idler pinion mountings of vehicle transmissions,
contact zones on inner cylindrical guide surfaces of cages, raceways or bearing rings and
contact zones on outer cylindrical guide surfaces of cages, raceways or bearing rings, particularly of externally or internally guided cages.

Ball blasting helps to increase the residual stresses on the surface of the contact zones treated in this way. The compressive residual stress extends into a depth range of down to 0.2 mm and possesses a maximum stress value of up to −1200 MPa. This value is obtained under the surface of the treated contact zone at a depth of 40 pm vertically under the surface. The compressive residual stress directly on the surface has a maximum value of −1000 MPa.

The zones of sliding contact, particularly in the case of cages, are the zones that undergo the strongest deformation, for example due to centrifugal forces. Because, as a rule, these zones are situated near the body edges of crossbars, side edges and cage pockets, they are particularly susceptible to notches and notch fractures caused by these. Gradually progressing fatigue processes due to the mechanical alternating loads lead to material fatigue and growth of cracks. The invention improves the fatigue strength of the zones concerned. The residual stresses produced prevent, for instance, incipient cracks (notches) and micro cracks from growing further, or inhibit their growth. Moreover, corrosion resistance is also improved.

The craters formed by this peening are micro pockets on the surface of the contact zones and are suitable for serving as reservoirs for particles of lubricants. In addition to this, the invention also proposes an optional, additional coating at least of the contact zones, so that particles of the coating get deposited in the craters and improve the lubrication and emergency running properties in/of the sliding contact. Shot peening leads to the formation of a characteristic surface comprising concave ball indentations produced by shot peening, so that an arithmetical mean deviation of the roughness profile on the surface in the range of 1 to 3 μm, preferably of 1 to 2 μm, is obtained. This occurs, for example, through treatment with granular blasting agents of circular shape in a grain size range of 0.2 to 0.5 mm.

The mean roughness value describes the roughness of a solid surface. The measured value is determined by scanning the surface of a defined measuring length or section. In this method, all the peak-to-valley deviations on the rough surface are registered. The arithmetical mean deviation of the roughness profile Ra is standardized, for example, according to DIN EN ISO 4287 dating from 1998.

Residual stresses are mechanical stresses that prevail in a solid metal body due to bracing of the metal lattice on which no outer forces are applied and which is in a state of thermal equilibrium. These stresses are caused, in the present case, through plastic deformations of the surface due to blasting with the blasting agent. The plastic deformations are, for instance, micro craters on the surface whose form and size depend on the type of blasting agent and the energy with which they strike the surface. Compressive residual stresses occur on solid body surfaces, in the present case, on the treated sliding zones.

Shot or ball blasting is also frequently designated as ball blast hardening. The term ball blasting is attributable to the use of a globular blasting agent. In ball blasting, small blasting-agent grains are hurled with the help of spinner, compressed air or injector jet devices at a high speed against the surface to be treated. This leads to the formation of artificial flaws in the atomic lattice of the metal surface which result in an enlargement of volume and, thus also, compressive residual stresses.

Ball blasting is used in the case of cages preferably on the traction side, i.e. on contact zones of outer cylindrical guide surfaces. This produces compressive residual stresses which counteract tensile stresses that are produced upon an oval deformation of the cage on the surfaces of these zones. Moreover, the corners of the pockets are endangered by notch cracks. Blasting of the cages is performed on the outside and the inside.

The invention further concerns a planetary transmission comprising at least one rolling bearing arrangement revolving about a central axis of the planetary transmission. The rolling bearing arrangement is formed by at least one planet pin and by rolling elements in the form of rollers or needles in rolling contact with the planet pin. The rolling elements are arranged in a cage. The cage comprises at least one contact zone for sliding contact with a further contact zone of the rolling bearing arrangement. At least one of the contact zones made out of steel is a treated surface with a maximum compressive residual stress of 900 to 1200 MPa obtained by blasting with solid particles.

The compressive residual stress extends with a changed value down to a depth of at least 0.25 mm vertically under the surface. According to one feature of the invention, the surface of the contact zone comprises randomly distributed indentations resulting from the blasting with solid particles. In this way, the surface, at least in the contact zone, possesses a roughness with an arithmetical mean deviation of the roughness profile in the range of 1 to 3 μm.

According to a further feature of the invention, the contact zone is formed at least on an outer cylindrical contour of the cage. The outer cylindrical contour is situated opposite an inner cylindrical peripheral surface. The inner cylindrical peripheral surface is integrally associated to a planet gear. The outer cylindrical contour and the inner cylindrical peripheral surface comprise the contact zones corresponding to each other for sliding contact. At least one of the contact zones comprises the surface treated by blasting. This surface can be the inner cylindrical peripheral surface of the bore of the planet gear but, alternatively, it can also be the radially outer surface on the cage.

### BRIEF DESCRIPTION OF THE DRAWINGS

The invention will now be described in more detail in the following with reference to examples of embodiment. The figures show:

FIG. 1 a perspective view of a rolling bearing arrangement comprising rolling elements and at least one cage guiding the rolling elements

FIG. 2 an enlarged perspective view of the cage of the rolling bearing arrangement according to FIG. 1, without rolling elements,

FIG. 3 a cross-section of the cage according to FIG. 2,

FIG. 4 the top view of one of the pockets of the cage according to FIG. 2,

FIG. 5 a simplified and schematic representation of a planetary transmission, and

FIG. 6 a possible configuration of the structure of a planetary transmission according to FIG. in a sectional representation along line VI-VI.

### DETAILED DESCRIPTION OF THE DRAWINGS

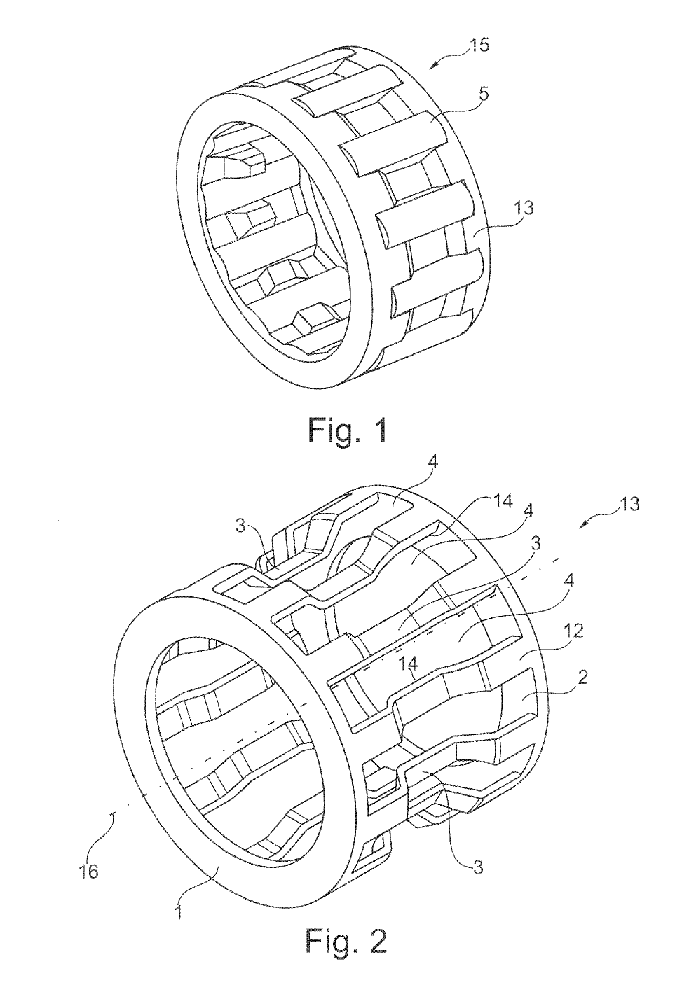

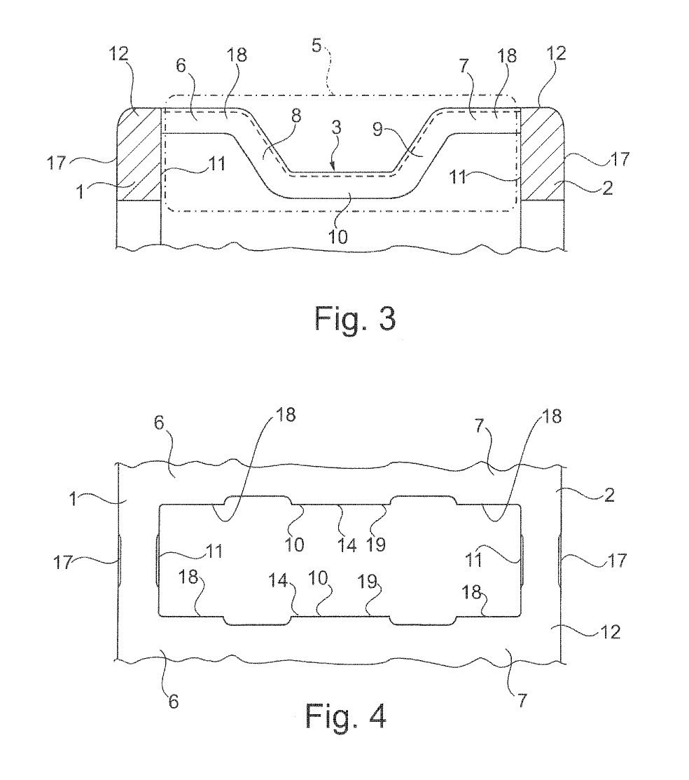

FIG. 1 shows a perspective view of a rolling bearing arrangement 15 comprising rolling elements 5 in the form of needles or rollers, and at least one cage 13 guiding the rolling elements 5. The cage 13 is illustrated in FIG. 2 in a perspective general view as a separate part without rolling elements. FIG. 3 shows the cross-section of the cage 13 according to FIG. 2 in a longitudinal section through the cage 13 extending parallel to the axis of rotation 16 of the cage 13.

FIG. 4 shows the top view of one of the pockets 4 of the cage according to FIG. 2.

The cage 13 is made, for instance, out of a widened and profiled pipe out of which the pockets 4 are punched out. Such cages are also designated as pressed cages. The advantage of pressed cages over so-called welded cages made of strip material resides, above all, in the fact that their periphery cannot be endangered by possibly existing notches in welded joints. However, it is still possible to use the invention alternatively in the case of so-called welded cages. Welded cages are made of strip material. The strip material is profiled and the pockets are punched out. The then ladder-shaped strip material is cut to the length of the circumference of the neutral fibers of the finished cage. Following this, the sheet metal strip is bent into a circular shape and the bent ends are brought together and connected to each other by welding at their abutting points.

The cage 13 is formed out of the side edges 1 and 2 as also of the crossbars 3 and possesses an M-shaped profile as shown in FIG. 3. Each of the crossbars 3 defines two pockets 4 in peripheral direction. The vertical bars of the M-profile are formed by the upright, in cross-section, rectangular profile of the side edges 1 and 2 that are formed at first by two sections 6 and 7 of the crossbar 3 extending parallel to the axis of rotation 16, which sections 6, 7 continue into inclined sections 8 and 9 and merge finally with the retention region comprising the retainer 10 extending parallel to the axis of rotation 16, for a roller 5, indicated in broken lines in FIG. 3, in each pocket.

Two contact zones 18 and 19, for instance, can be formed on the inner edge of the crossbar 3. These contact zones 18, 19 are zones for sliding contact with the respective rolling element 5 in the pocket 4. It is possible to make the contact zones 18 on the sections 6 and 7. The sliding contact with the rotating rolling elements 5 can occur on these contact zones 18, if the rolling elements 5 are supported in the pockets 4 against interlacing relative to the axially parallel position. The contact zones 19 are defined by the cage retainer 10 against which the rolling elements abut during rotation and entrain the cage 13 in circumferential direction.

In addition to this, contact zones 11 for a sliding contact with the front ends of the respective roller 5 are configured in the pockets 4 on the side edges 1 and 2. Sliding contact occurs particularly if the rollers 5 come into an inclined position in the pocket 4 within the pocket clearance and are thus forcedly displaced crosswise to the circumferential direction (so-called screwing of the rollers) by axial forces. Further, possible contact zones 17 are configured on the outer sides of the side edges 1 and 2. A sliding contact with thrust washers occurs on these zones particularly in planet mountings due to deformations of the planet pins and carriers and the resulting screwing of the rollers 5.

Preferred contact zones on the cage 13 are the contact zones 12 on the outer periphery of the cage 13 which are formed by outer cylindrical surfaces of the side edges 1 and 2. These contact zones 12 are the guide surfaces for an outer guidance of the cages in planet gears for rolling bearing arrangements for mounting planet gears as described above under the heading “Background of the invention”. In this example, the contact surfaces 12 and 17 are ball blasted by way of example and this is meant to be symbolized by the thick-outlined regions.

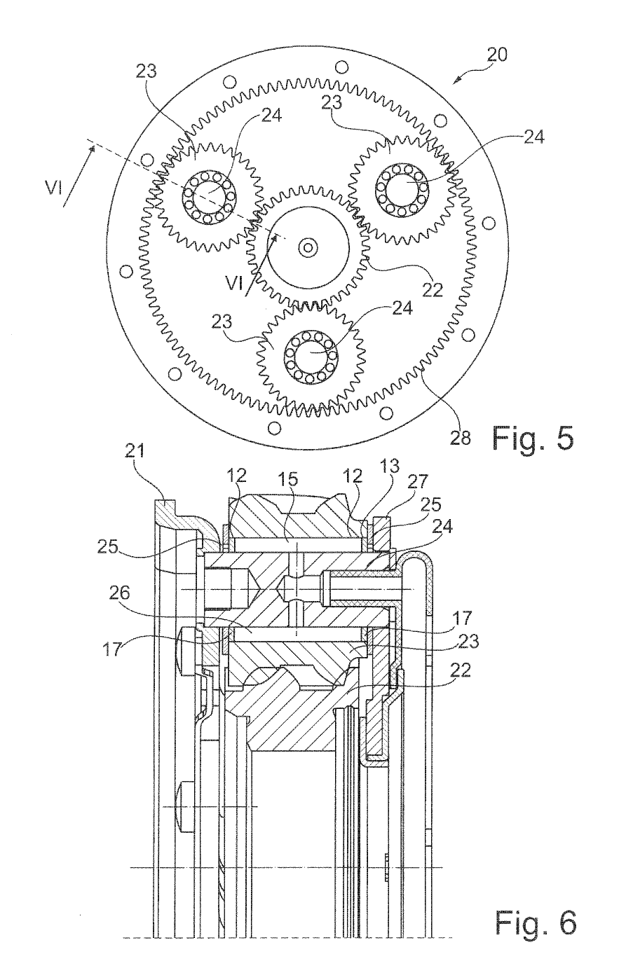

FIG. 5 shows a simplified and schematic representation of a planetary transmission 20 and FIG. 6, a possible configuration of the structure of a planetary transmission 20 according to FIG. 5 in a sectional representation along line VI-VI. The planetary transmission 20 is made up of two planet carriers 21 and 27, a sun gear 22 engaged with planet gears 23 mounted on planet pins 24 and engaged with an annulus 28. Each of the planet gears 23 is mounted, for instance, with help of a rolling bearing arrangement 15 on the respective planet pin 24. The contact zones 17 are situated opposite thrust washers 25 which, in turn, comprise surface-like contact zones for sliding contact with the cage 13. The contact zones 12 are situated opposite corresponding contact zones on the inner cylindrical peripheral surface of the bore 26 of the respective planet gear 23 on which the cage 13 is externally guided.

1-7. (canceled)

8. A rolling bearing arrangement, comprising:
rolling elements; and
at least one cage guiding the rolling elements, the cage having at least one contact zone for sliding contact with a further contact zone, the at least one contact zone has a treated surface with a maximum compressive residual stress of 900 to 1200 MPA obtained by blasting with solid particles, the compressive residual stress extending with a changed value down to a depth of at least 0.25 mm vertically under the treated surface.

9. The rolling bearing arrangement according to claim 8, wherein the treated surface has randomly distributed indentations formed by the blasting with the solid particles so that the treated surface of the at least one contact zone possesses a roughness having an arithmetical mean deviation of a roughness profile in a range of 1 to 3 μm.

10. The rolling bearing arrangement according to claim 8, wherein the cage has surfaces and the at least one contact zone is formed at the surfaces of the cage.

11. A method of producing at least one contact zone of a cage, comprising the following steps:
blasting the contact zone with a blasting agent in form of round particles having a size in a range of 0.2 to 0.5 mm with at least a surface hardness of the particles being at least higher than a surface hardness of the contact zone.

12. A planetary transmission rotatable about a central axis, comprising:
at least one rolling bearing arrangement revolving about the central axis of the planetary transmission,
the rolling bearing arrangement having at least one planet pin, rollers in rolling contact with the planet pin, and a cage in which the rollers are arranged,
the cage having at least one contact zone for sliding contact with a further contact zone in the planetary transmission,
wherein the at least one contact zone is made out of steel and is a treated surface having a maximum compressive residual stress of 900 to 1200 MPa obtained by blasting with solid particles, and the compressive residual stress extends with a changed value down to a depth of at least 0.25 mm vertically under the treated surface.

13. The planetary transmission according to claim 12, wherein the treated surface has randomly distributed indentations formed by blasting with the solid particles, so that the treated surface of the at least one contact zone possesses a roughness having an arithmetical mean deviation of a roughness profile in a range of 1 to 3 μm.

14. The planetary transmission according to claim 12, further comprising a planet gear, wherein the at least one contact zone is formed at least on an outer cylindrical surface of the cage, the outer cylindrical surface being situated opposite an inner cylindrical peripheral surface integrally associated to the planet gear, and the outer cylindrical surface and the inner cylindrical peripheral surface respectively having the contact zone and the further contact zone correspond to each other for sliding contact.
